(19) United States
(12) Patent Application Publication
(10) Pub. No.: US 2006/0178982 A1
(43) Pub. Date: Aug. 10, 2006

(54) Method and system for executing data analytics on a varying number of records within a RDBMS using SQL

(75) Inventors: Mark Steven Ramsey, Colleyville, TX (US); Milind Chitgupakar, Omaha, NE (US)

Correspondence Address: RICHARD M. GOLDMAN, 371 ELAN VILLAGE LANE, SUITE 208, CA, 95134, US

(73) Assignee: International Business Machines Corporation

(21) Appl. No.: 11/053,225

(22) Filed: Feb. 8, 2005

(51) Int. Cl. G06F 17/30; G06Q 40/00

(52) U.S. Cl. 705/38

(57) ABSTRACT

Scoring and detecting anomalies in a dynamic number of transaction records within a relational database management system by initiating a function for accepting and storing a transaction record in the relational database management system; This function and the analytics are integral to the RDBMS, as distinguished from extracting the data and passing the data to a separate application external to the RDBMS. The function determines if the transaction is for a different individual then a previous transaction or for the same individual. If the transaction is not for a different individual, adding the new transaction data to a memory work space and returning a NULL statement, otherwise passing the memory work space to a service. In the next step the memory workspace is accepted and an analytic model is executed to produce a score, and return the score to a calling function. This score is received at the calling function, the memory work space for the individual is released, and the score is returned to the calling statement. All of the NULL statements are collapsed and a single record is retained for the individual. This record contains the score, that is, a buying preference or pattern, a travel pattern, a calling pattern, a maintenance prediction, a risk score, or a credit score, by way of illustration.

### BACKGROUND OF THE INVENTION

1. Field of the Invention

The present invention relates to an RDBMS-based, computerized method, system, and program product for analyzing large volumes of transactions, such as purchasing patterns of goods and services, repair orders, inventory actions involving spare parts or merchandise, detecting anomalous transactions including potentially fraudulent transactions, possible instances of identity theft, and evidence of inventory shrinkage in transaction clearing processes and systems, such as check processing, automatic teller machine processing, credit card processing, portfolio management, and inventory management, all across multiple customers and sites.

2. Description of Related Art

a. Overview

Numerous businesses process large numbers of transactions, including purchases of goods and services, repairs, maintenance management, inventory management, check clearing, bank account deposits and withdrawals, automatic teller machine transaction processing, credit card and debit card transactions, investment portfolio transactions (such as securities long sales and short sales, securities purchases, and margin account transactions), inventory management, and the like. The number of transactions per customer, the number of customers, the sequence of transactions, the frequency of transactions, and the magnitude of total transactions can show subtle relationships, predict events, and conceal various anomalous transactions, including fraud, inventory shrinkage, credit worthiness problems, and identity theft.

For example, a credit card company may create a risk score or a fraud score for a customer based on an analysis of that customer's usage of the credit card during a finite period, such as sixty or ninety days. Since different typical customers may have used their credit cards different numbers of times during the sixty or ninety days, the actual number of transactions for a specific customer will not be known in advance. It is frequently necessary to capture a customer's transaction history, for example, to derive a risk score, or to detect an anomalous set of transactions, for entry into an RDBMS, for subsequent access and use by other applications or processes.

Similarly, POS (Point of Sale) transaction analysis, either alone or in conjunction with customer loyalty and affinity programs allows a merchant to review market baskets, which vary between customers and for one customer over time, to analyze customer behavior.

Another area of transaction analysis is inventory management, including maintenance management and predictive maintenance. In this context transaction analysis of seemingly unrelated sub-unit failures can be a predictor of larger future system failures. Previously, these transaction analysis tasks have had a high overhead cost, especially in terms of processing, memory operations, and system bandwidth. There are several current approaches for this problem. One approach is for the data to be pre-processed by the RDBMS and then passed to an analytic application as an extracted flat file. Alternatively, an application can be written and used to retrieve specific data for each individual customer and pass the data to the analytic application for analysis. In each case, the score is captured into the RDBMS by again accessing the RDBMS.

Given the very large numbers of transactions and processes, and the opportunity for anomalies and patterns (or elements of patterns) in any one transaction or in a small set of transactions, all within a large universe of transactions, a clear need exists for a method, system, and program product to produce an individual customer score (as a risk assessment, buying pattern, customer loyalty, calling pattern, travel pattern, maintenance and/or spare parts pattern) result for an individual customer whose files are in the RDBMS, and to produce the customer score quickly and simply with minimal system overhead.

When a “customer score” is referred to herein, it is to be understood that the method, system, and program product described herein can be used to detect such profile items as buying patterns, calling patterns, travel patterns, spare parts and maintenance requirements, as well as anomalies in check processing, bank account deposits and withdrawals, automatic teller machine transaction processing, credit card and debit card transactions, investment portfolio transactions (such as securities long sales and short sales, securities purchases, and margin account transactions), inventory management, and the like, and unless the context indicates the contrary, such transactions are intend to be encompassed within the broad term of “customer score.”

### SUMMARY OF THE INVENTION

Described herein is a method, system, and program product to produce an individual customer score result for an individual customer whose files are in a RDBMS, and to produce the customer score quickly and simply with minimal system overhead.

The method, system, and program product provide for executing data analytics on a dynamically varying number of records within a relational database management system using RDBMS assets and SQL statements. This is done by initiating a function for accepting and storing a transaction record, that is, an individual's or customer's transactions, in the relational database management system using functions and analytics integral to the RDBMS. The next step is using the function, which may be a set or suite of functions, to determine if a transaction is for a different individual or customer, then a previous transaction. If the transaction is not for a different individual or customer, the new transaction is added to a memory work space and a NULL statement is returned. If, however, the transaction is for a different individual the work space is passed to a service.

Next, the RDBMS accepts the memory work space and executes the analytic model to produce a score. That is, a service, such as DB2 Scoring accepts the memory work space passed to it, and executes the analytic model or models to produce a result, such as the identification or measurement of an output, such as a score, including or indicating an opportunity or an anomaly. The score, including or indicating an opportunity or anomaly can be a measure of customer loyalty, purchasing patterns, calling patterns, travel patterns, a risk score, a possibly fraudulent transaction, a possible identity theft, an adverse reaction to a pharmaceutical, or a security or terrorism risk. Upon completing the score, the service returns the score to the calling function. As described herein, the score returned by the analytic model indicates an opportunity or an anomaly. The anomaly may be a financial risk, possibly fraudulent transactions, possible identity theft, an adverse reaction to a drug under test, while the opportunity may be a maintenance need, a buying pattern or preference, a calling pattern or travel pattern or preference, or the like.

This score is returned to the calling SQL statement. The function receives the score, releases the memory, and returns the score to the calling SQL statement.

The RDBMS receives the score, as a loyalty score, a buying, calling, or travel preference, a maintenance prediction, a risk score, a credit score, a threat score, or anomaly identification from the application described herein, and releases the held memory work space for the previous individual. The transaction that initiated the call to the service is then placed at the top of the memory space. The function returns the score, that is, the opportunity, risk, threat, credit, or anomaly score to the calling SQL statement, rather then returning a NULL. All of the NULL statements are collapsed, and a single record, arrayed by individual or customer, and containing the score, is retained.

As described herein, the relational database management system directly accesses the data, pre-processes the data, analyzes the data, and generates the anomaly or risk score or measure.

The number of records identified to a particular customer is a varying number of records within the relational database management system, that is, a dynamically varying number of records. By a dynamically varying numbers of records per individual, we mean that the analytics are applied to nᵢ records for the i-th individual account holder, where nᵢ itself is variable over time, and thereafter the analytics are applied to nⱼ records for the j-th individual account holder, again, where nⱼ itself is also variable over time, and where, for example, individuals i and j occupy different parts of RDBMS address space and the number of analyzed transactions is different from one individual account holder to another individual account holder, and is different over time. In this way, the method and system of our invention analyzes the then current nᵢ transactions within the i-th individual's record generates the score or risk factor for the i-th individual or customer, and then analyzes the then current nⱼ transactions within another individual's record, that is, the j-th individual's records.

The database extension accepts each transaction record, and stores the transaction record in the relational database management system's memory space. Next, the database extension determines if the most recent transaction matches the individual or customer of the previous transaction or is for a new individual. When the transaction matches that of the previous transaction, the transaction data is added to the memory work space, and a NULL is returned by the function. When the function determines that the individual or customer does not match that of the previous transaction, the processes memory work space is passed to the RBDMS and its functionality.

The execution of the analytic analysis is executed using the SQL database command language. To achieve the result of the individual score being returned by the calling SQL statement, the result set must be returned as one record for each individual, that is, one record from the set of transactions for the individual. This may be accomplished by having the calling SQL statement using the database function MAX( ) when calling the analytics function. This serves to collapse all of the returned NULL values from the function, and retains the single record by individual that contains the calculated score.

The function for accepting and storing the transaction record in the relational database management system may be a user defined function, or a vendor supplied function. In a preferred exemplification of our invention access to the function for accepting and storing a transaction record in the relational database management system is web accessible, and the function for accepting and storing a transaction record in the relational database management system utilizes SQL functionality.

### BRIEF DESCRIPTION OF THE DRAWINGS

The above objects and advantages of the invention will be illustrated by describing in detail the preferred embodiments thereof with reference to the attached drawings:

FIG. 1 is a high level functional diagram of a credit card system having a credit card reader for entering details of a transaction at a merchant terminal, an intermediate level data processing system at the merchant's bank, a data processing system at the credit card issuer's bank (that is, the customer's bank), and a terminal connected to the data processing system at the credit card issuer's bank. The data processing system at the credit card issuer's bank houses a RDBMS for credit cards issued by the bank including the system for executing data analytics on a varying number of records, for example, credit card records, within a RDBMS using SQL.

FIG. 2 is a high level flow chart illustrating a simplified overview of a method and the operation of a system for executing data analytics on a varying number of records, for example, credit card records, within a RDBMS using SQL.

FIG. 3 shows an excerpt from a RDMS, with account numbers, transaction numbers, and transaction amounts, where the first six transactions, transactions 1001 to 1006, of account 123 are read into the function for executing data analytics on the varying number of records (that is, six records for account 123 or three records for account 690), triggering the execution of the data analytics on the varying number of records. Transaction 1004, for $1200.12, could trigger further processing.

### DETAILED DESCRIPTION

Within the context of very large numbers of transactions and processes, and with the opportunity for opportunities, relations, and anomalies in any one transaction or in a small set of transactions, all within a large universe of transactions, it is an object of our invention to provide a method, system, and program product to produce an individual customer score result for an individual customer whose files are in an RDBMS, and produce the customer score quickly and simply with minimal system overhead.

The method, system, and program product described herein produces an individual customer score result for an individual customer whose files are in a RDBMS, and is capable of producing this customer score quickly and simply with minimal system overhead.

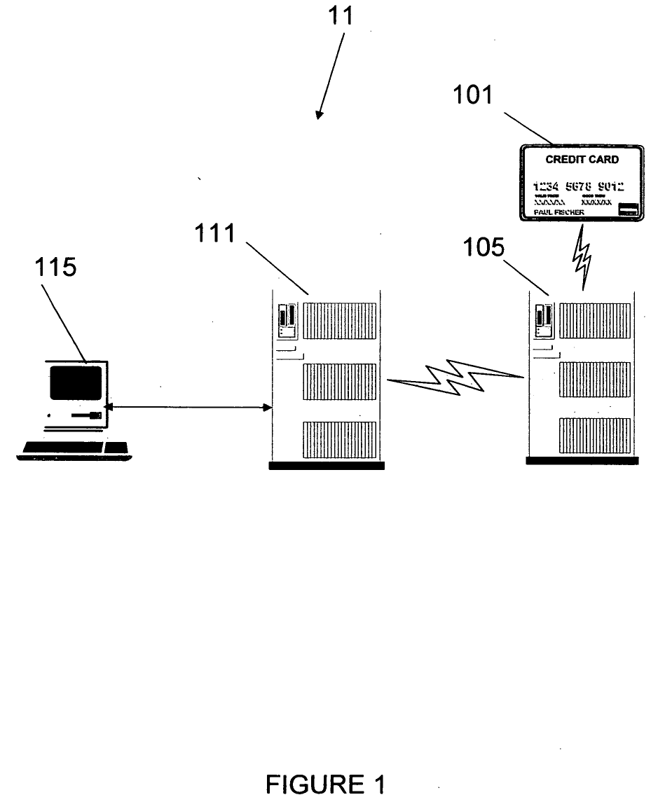

FIG. 1 illustrates a high level functional diagram of a credit card system 11 having a credit card reader, here represented generally by a credit card 101, for entering details of a transaction at a merchant terminal, an intermediate level data processing system 105 at the merchant's bank, a data processing system at the credit card issuer's bank 111 (that is, the customer's bank), and a terminal 115 connected to the data processing system 111 at the credit card issuer's bank. The data processing system 111 at the credit card issuer's bank houses a RDBMS for credit cards issued by the bank, including the system described herein for executing data analytics on a varying number of records, for example, credit card records, within a RDBMS using SQL.

It is to be noted that a credit card system 11 is used by way of exemplification and not limitation.

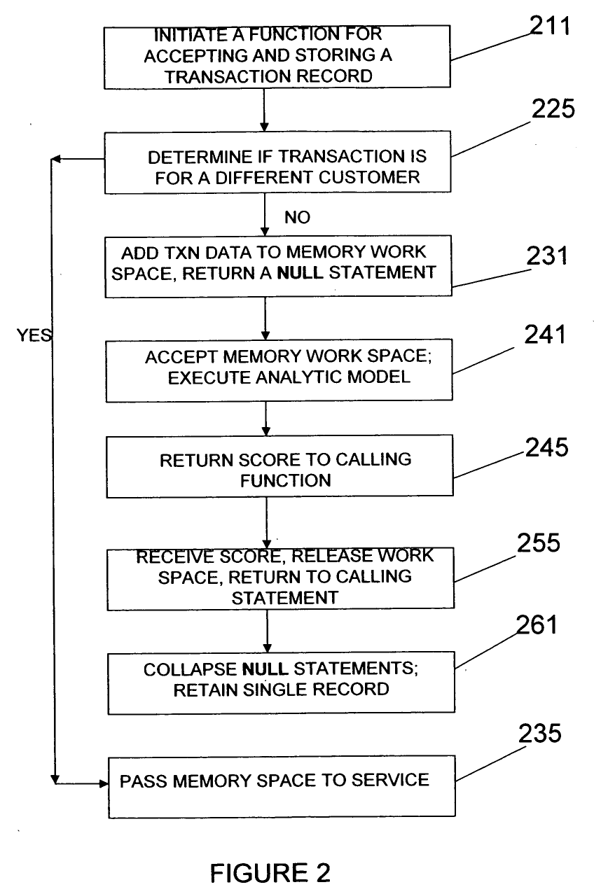

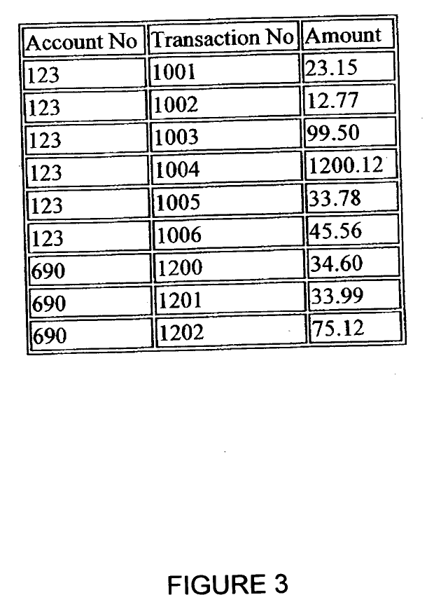

The method, system, and program product, illustrated generally in the flow chart of FIG. 2, executes data analytics on a dynamically varying number of records, illustrated generally in the table of FIG. 3, within a relational database management system. This is done by initiating the function described herein for accepting and storing a transaction record, that is, an individual customer's transactions, in the relational database management system using functions and analytics integral to the RDBMS, block 211 in FIG. 2.

The next step is using the function, which may be a set or suite of functions, to determine if a transaction is for a different individual then a previous transaction 221. If the transaction is not for a different individual, the new transaction is added to a memory work space and a NULL statement is returned 231. If, however, the transaction is for a different individual the work space is passed to a service 235. The database extension accepts each transaction record, and stores the transaction record in the relational database management system's memory space. The database extension determines if the most recent transaction matches the individual or customer of the previous transaction or is for a new individual. When the customer or individual matches that of the previous transaction, the transaction data is added to the memory work space, and a NULL is returned by the function. When the function determines that the individual or customer does not match that of the previous transaction, the processes memory work space is passed to the RBDMS and its functionality.

Next, the RDBMS accepts the memory work space and executes an analytic model to produce a score 241. Specifically, a service, such as DB2 Scoring accepts the memory work space passed to it, and executes the analytic model or models to produce a result, such as the identification or measurement of an output, such as a score or an anomaly.

The score or anomaly can be a risk score, a possibly fraudulent transaction, a possible identity theft, an adverse reaction to a pharmaceutical, or a security or terrorism risk. Upon completing the score, the service returns the score to the calling function.

This score is returned to a calling function 245. The calling function receives the score, releases the memory, and returns the score to the calling function 255. All of the NULL statements are collapsed, and a single record, arrayed by individual, and containing the score, is retained 261. The RDBMS receives the score, such as an opportunity, a customer preference or buying pattern, a calling pattern, a travel pattern, a maintenance prediction, a risk score, a credit score, a threat score, or an anomaly identification from the application described herein, and releases the held memory work space for the previous individual. The transaction that initiated the call to the service is then placed at the top of the memory space. The function returns the risk, threat, credit, or anomaly score to the calling SQL statement, rather then returning a NULL.

The score analysis is executed within the RDBMS using the SQL database command language. To achieve the result of the individual score being returned by the calling SQL statement, the result set must be returned as one record for each individual, that is, one record from the set of transactions for the individual. This may be accomplished by having the calling SQL statement using the database function MAX( ) when calling the analytics function. This serves to collapse all of the returned NULL values from the function, and retains the single record by individual that contains the calculated score.

As described herein, the relational database management system directly accesses the data, pre-processes the data, analyzes the data, and generates the anomaly or risk score or measure.

FIG. 3 shows an excerpt from a RDMS, with account numbers, transaction numbers, and transaction amounts, where the first six transactions, transactions 1001 to 1006, of account 123 are read into the function for executing data analytics on the varying number of records (that is, six records for account 123 or three records for account 690), triggering the execution of the data analytics on the varying number of records. Transaction 1004, for $1200.12, could trigger further processing.

Returning to FIG. 2, the number of records identified to a particular customer or individual in block 225 is a dynamically varying number of records within the relational database management system, that is, a dynamically varying number of records. By a dynamically varying numbers of records per individual, we mean that the analytics are applied to nᵢ records for the i-th individual account holder, where nᵢ itself is variable over time, and thereafter the analytics are applied to nⱼ records for the j-th individual account holder, again, where nⱼ itself is also variable over time, and where, for example, individuals i and j occupy different parts of RDBMS address space and the number of analyzed transactions is different from one individual account holder to another individual account holder, and is different over time. In this way, the method and system of our invention analyzes the then current nᵢ transactions within the i-th individual's record and then analyzes the then current nⱼ transactions within another individual's record, that is, the j-th individual's records.

The function described herein for accepting and storing the transaction record in the relational database management system may be a user defined function or a vendor supplied function. Access to the function by a suitably authorized user my be over the web, that is, through a web browser.

The actual function for accepting and storing the transaction record in the relational database management system typically utilizes SQL functions.

As described herein the score returned by the analytic model indicates a relationship, an opportunity, or an anomaly. The opportunity, relationship, or anomaly may be a buying pattern or preference, a calling pattern or preference, an indication of customer loyalty, financial risk, a possibly fraudulent transaction, a possible identity theft, an adverse reaction to a drug under test, or an inventory withdrawal or shrinkage or other inventory anomaly or event (indicating, for example shrinkage, sales, or maintenance needs).

The invention may be implemented, for example, by having the system for executing data analytics of a dynamic varying number of records as a software application (as an operating system element), a dedicated processor, or a dedicated processor with dedicated code. The code executes a sequence of machine-readable instructions, which can also be referred to as code. These instructions may reside in various types of signal-bearing media. In this respect, one aspect of the present invention concerns a program product, comprising a signal-bearing medium or signal-bearing media tangibly embodying a program of machine-readable instructions executable by a digital processing apparatus to perform a method for executing data analytics of a dynamic varying number of records in a relational database management system.

This signal-bearing medium may comprise, for example, memory in a server. The memory in the server may be non-volatile storage, a data disc, or even memory on a vendor server for downloading to a processor for installation. Alternatively, the instructions may be embodied in a signal-bearing medium such as the optical data storage disc. Alternatively, the instructions may be stored on any of a variety of machine-readable data storage mediums or media, which may include, for example, a “hard drive”, a RAID array, a RAMAC, a magnetic data storage diskette (such as a floppy disk), magnetic tape, digital optical tape, RAM, ROM, EPROM, EEPROM, flash memory, magneto-optical storage, paper punch cards, or any other suitable signal-bearing media including transmission media such as digital and/or analog communications links, which may be electrical, optical, and/or wireless. As an example, the machine-readable instructions may comprise software object code, compiled from a language such as “C++”, Java, Pascal, ADA, assembler, and the like.

Additionally, the program code may, for example, be compressed, encrypted, or both, and may include executable files, script files and wizards for installation, as in Zip files and cab files. As used herein the term machine-readable instructions or code residing in or on signal-bearing media include all of the above means of delivery.

While the foregoing disclosure shows a number of illustrative embodiments of the invention, it will be apparent to those skilled in the art that various changes and modifications can be made herein without departing from the scope of the invention as defined by the appended claims. Furthermore, although elements of the invention may be described or claimed in the singular, the plural is contemplated unless limitation to the singular is explicitly stated.

We claim:

1. A method of executing data analytics on a varying number of records within a relational database management system comprising:
a) initiating a function for accepting and storing a transaction record in the relational database management system;
b) determining by said function if the transaction is for a different individual then a previous transaction;
c) if said transaction is not for a different individual, adding the new transaction data to a memory work space and returning a NULL statement, else passing said memory work space to a service;
d) accepting the memory work space and executing an analytic model to produce a score, and returning said score to a calling function;
e) receiving said score at said calling function, releasing said memory work space for said individual, and returning said score to a calling statement; and
f) collapsing said NULL statements and retaining a single record for an individual, said record containing said score.

2. The method of claim 1 wherein the varying number of records within the relational database management system is a dynamically varying number of records.

3. The method of claim 1 wherein the function for accepting and storing the transaction record in the relational database management system is a user defined function.

4. The method of claim 1 wherein the function for accepting and storing a transaction record in the relational database management system is a vendor supplied function.

5. The method of claim 1 wherein the function for accepting and storing a transaction record in the relational database management system is web accessible.

6. The method of claim 1 wherein the function for accepting and storing a transaction record in the relational database management system utilized SQL functionality.

7. The method of claim 1 wherein said score returned by said analytic model indicates an opportunity, relationship, or an anomaly.

8. A computer system adapted to process transaction records for executing data analytics on a varying number of records within a relational database management system by a method comprising:
a) initiating a function for accepting and storing a transaction record in the relational database management system;
b) determining by said function if the transaction is for a different individual then a previous transaction;
c) if said transaction is not for a different individual, adding the new transaction data to a memory work space and returning a NULL statement, else passing said memory work space to a service;
d) accepting the memory work space and executing an analytic model to produce a score, and returning said score to a calling function;
e) receiving said score at said calling function, releasing said memory work space for said individual, and returning said score to a calling statement; and
f) collapsing said NULL statements and retaining a single record for an individual, said record containing said score.

9. The computer system of claim 8 wherein the number of records within the relational database management system processed by the computer system is a dynamically varying number of records.

10. The computer system of claim 8 wherein the function for accepting and storing the transaction record in the relational database management system is a user defined function.

11. The computer system of claim 8 wherein the function for accepting and storing a transaction record in the relational database management system is a vendor supplied function.

12. The computer system of claim 8 wherein the function for accepting and storing a transaction record in the relational database management system is web accessible.

13. The computer system of claim 8 wherein the function for accepting and storing a transaction record in the relational database management system utilized SQL functionality.

14. The computer system of claim 8 wherein said score returned by said analytic model indicates an opportunity, a relationship, or an anomaly.

15. A program product for configuring and controlling a computer system to process transaction records for executing data analytics on a varying number of records within a relational database management system by a method comprising:
a) initiating a function for accepting and storing a transaction record in the relational database management system;
b) determining by said function if the transaction is for a different individual then a previous transaction;
c) if said transaction is not for a different individual, adding the new transaction data to a memory work space and returning a NULL statement, else passing said memory work space to a service;
d) accepting the memory work space and executing an analytic model to produce a score, and returning said score to a calling function;
e) receiving said score at said calling function, releasing said memory work space for said individual, and returning said score to a calling statement; and
f) collapsing said NULL statements and retaining a single record for an individual, said record containing said score.

16. The program product of claim 15 wherein the number of records within the relational database management system processed by the computer system is a dynamically varying number of records.

17. The program product of claim 15 wherein the function for accepting and storing the transaction record in the relational database management system is a user defined function.

18. The program product of claim 15 wherein the function for accepting and storing a transaction record in the relational database management system is a vendor supplied function.

19. The program product of claim 15 wherein the function for accepting and storing a transaction record in the relational database management system is web accessible.

20. The program product of claim 15 wherein the function for accepting and storing a transaction record in the relational database management system utilized SQL functionality.

21. The program product of claim 15 wherein said score returned by said analytic model indicates an opportunity, a relationship, or an anomaly.
